(19) United States
(12) Patent Application Publication
(10) Pub. No.: US 2007/0194934 A1
(43) Pub. Date: Aug. 23, 2007

(54) Foil Security Element

(76) Inventor: Reinhard Tauber, Miesbach (DE)

Correspondence Address: BACON & THOMAS, PLLC, 625 SLATERS LANE, FOURTH FLOOR, ALEXANDRIA, VA, 22314, US

(21) Appl. No.: 10/571,117

(22) PCT Filed: Sep. 7, 2004
(86) PCT No.: PCT/EP04/09971

§ 371 Date: Nov. 17, 2006

(30) Foreign Application Priority Data
Sep. 11, 2003 (DE) 10342252.8

(51) Int. Cl. G08B 13/14; G06K 19/00

(52) U.S. Cl. 340/572.8; 235/487

(57) ABSTRACT

The invention relates to a data carrier, such as a bank note, paper of value, identity card or the like, having a foil security element (12) disposed on the surface thereof. The foil element contains according to the invention a break-through area (16) with at least one gap breaking through the element, or a window area, through which a subjacent security feature (18) of the data carrier is recognizable.

This invention relates to a foil security element for application to a data carrier, such as a bank note, paper of value, identity card or the like, having a foil substrate provided with a security feature. The invention also relates to a data carrier having such a foil security element as well as a production method for such a data carrier.

Data carriers and in particular value documents are as a rule equipped for security reasons with security elements which allow a check of the authenticity of the data carrier and at the same time serve as protection from unauthorized reproduction of the data carrier. The security elements used are often optically variable elements which convey to the viewer different pictorial impressions, for example different color effects, from different viewing angles.

To increase the falsification security it is known to combine such security elements with through openings in the value documents. For example, the print WO 95/10420 proposes punching a through aperture in a value document after its production and closing the aperture on one side with a covering film which projects beyond the aperture on all sides. If the covering film is transparent at least in partial areas, the base surface shows through when the value document is copied, thus making the copy recognizable as such. The covering film can additionally have a security feature, such as a hologram.

The invention is based on the problem of specifying a security element of the type stated at the outset that permits effective securing of a data carrier. In particular, the secured data carrier should both be hard to imitate and permit a check of authenticity or intactness by a layman.

This problem is solved by the foil security element having the features of the main claim and the first coordinated claim. A data carrier having such a foil security element as well as a production method for such a data carrier are the subject matter of further coordinated claims. Developments of the invention are stated in the sub-claims.

A foil security element of the type stated at the outset has, according to a first aspect of the invention, a break-through area with at least one gap breaking through the element. In a preferred embodiment, the break-through area contains a plurality of gaps breaking through the element in the form of patterns, characters or codings. The break-through area can also have an extensive gap through which a subjacent security feature of the data carrier is recognizable.

The invention is based in this aspect on the idea that such a break-through area is hard to imitate primarily when it contains a multiplicity of small gaps disposed in a characteristic pattern or has an edge provided with fine-scale structures. The gaps can be disposed in the form of a picture motif, e.g. a stylized portrait or an architectural motif, or in the form of alphanumeric characters representing certain information, such as the denomination or the issuing country of a bank note.

Simultaneously, the break-through area is easily feelable and detectable haptically for the user. The presence or absence of a break-through area can thus often be detected reliably without an optical check. Obviously, the presence of the break-through area can also be checked by machine. In connection with a security element disposed under the break-through area there are additional possibilities of securing, which will be described more exactly below.

According to a second aspect of the invention, a generic foil security element has a window area through which a subjacent security feature of the data carrier is recognizable. Like the break-through area of the first aspect of the invention, the window area can also be designed advantageously in the form of patterns, characters or a coding.

The invention furthermore comprises a data carrier, such as a bank note, a paper of value, an identity card or the like, having a foil security element of the described type disposed on the surface thereof. This permits a correlation to be produced between the information on the data carrier and the information on the foil element, which prevents attempts at forgery or tampering or at least makes them easily recognizable.

In the preferred embodiment, the data carrier has a security feature that is covered at least partly by the foil security element and recognizable visually and/or by machine through the break-through area or the window area. The cover protects the security feature and makes it impossible or difficult to access for interventions. At the same time, the security feature can be easily detected via the break-through or window area of the foil security element.

According to an advantageous embodiment of the inventive data carrier, the security feature is embedded inside the data carrier. Examples of embedded security features are watermarks or mottling fibers in a security paper.

Alternatively, the data carrier can be provided in a partial area with a security layer containing the security feature. The security layer preferably contains at least one security feature which is selected from the group of luminescent, metallic, magnetic or electroconductive substances or optically variable pigments. If the security layer of a value document contains a luminescent substance, for example, a copy of the document can be easily recognized, since luminescent substances cannot be reproduced with common color copiers, or not true to the original.

According to a preferred embodiment, the data carrier contains a transparent or translucent area which is recognizable through the break-through area or the window area. A translucent area can be produced in a value document for example by the action of certain substances on the paper substrate, such as concentrated sulfuric acid, zinc chloride, fats, resins, waxes, synthetic polymers, such as terpene polymers, polyurethanes, methyl methacrylate, etc.

If the data carrier contains a transparent substrate, e.g. a transparent plastic film, the transparent area can be formed simply by one or more gaps in an applied opaque or semitransparent cover layer. The overall result is a through-going transparent or translucent area which gives the data carrier a striking and characteristic appearance in transmission.

According to an advantageous development of the invention, the data carrier contains at least two security features with different physical properties which are recognizable visually and/or by machine through the break-through area or the window area. The security features can be disposed side by side, one above the other, or partly overlapping each other. A first security feature can be selected e.g. to be easily checked by the viewer, while a second security feature is selected from the point of view of particularly high falsification security.

For example, the two security features can be formed by two separate zones of the security layer which contain different luminescent marking substances. The first marking substance has e.g. an emission wavelength in the visible spectral range, so that it can be detected with the naked eye without problems after excitation by a suitable source. The second marking substance has, in contrast, an emission wavelength in the infrared spectral range, in particular in the range above about 1100 to 1200 nm, so that the luminescence of this marking substance cannot be detected with the widespread silicon infrared detectors, but requires more elaborate detectors not available to everyone.

The break-through area or window area of the foil security element, according to an advantageous development of the invention, forms visually and/or machine detectable information which is identical in content to, or supplements, other information on the data carrier or the foil security element. Examples of such information are the denomination of a bank note, the currency, the issue date, the country, the printing plant or another special feature of the data carrier. One or more of the stated items of information can be read and processed during the authenticity check. Such a correspondence permits a relation to be produced between data carrier and foil security element, which makes tampering, such as the detachment and transfer of the foil security element to another data carrier, readily obvious.

In an expedient embodiment of the invention, at least part of the information on the data carrier is detectable visually and/or by machine through the break-through area or the window area.

In a further embodiment of the invention, not only the foil security element has a break-through or window area, but at the same time also the data carrier. The break-through or window areas preferably overlap at least partly, and particularly preferably they are congruent. In a further variant, the break-through or window area in the data carrier is covered with a further foil on the side facing away from the data carrier side bearing the foil security element.

The foil security elements according to both aspects of the invention can form a security strip, a security thread and in particular a flat transfer element for application to a data carrier.

A “transfer element” according to the invention refers to a foil security element that is prepared on a separate carrier layer, for example a plastic foil, in the reverse order as it will later come to lie on the security paper, and then transferred to the security paper by means of an adhesive or lacquer layer in the desired outline forms. The carrier layer can be removed from the layer structure of the security element after transfer, or remain as a protective layer on the layer structure as an integral part of the security element.

The individual transfer elements can be prepared on the carrier layer as separate individual elements in the outline forms to be transferred. Alternatively, the layer sequence of the transfer elements is provided on the carrier layer in continuous form. Such carrier layers with spaced-apart individual transfer elements or a continuously extending layer structure will hereinafter be designated “transfer material”, and the layer sequence of the security element disposed on the carrier layer the “transfer layer”.

In the case of the continuous transfer layer, the transfer material is then connected to the security paper via an adhesive layer, and the adhesive layer activated using corresponding embossing tools, so that the transfer layer adheres to the security paper only in the activated areas. All other areas are then removed with the carrier layer. Alternatively, the adhesive layer can also be executed in the form of the security element to be transferred. The adhesives used are preferably hot-melt adhesives. However, any other adhesives, such as reaction lacquers, can also be used.

The foil security element, in an advantageous development, is applied to the data carrier in register to further increase the falsification security. It can in particular be applied in register with the total geometry of the data carrier or with an embedded or applied feature of the data carrier. In particular, the foil security element is so applied that the break-through or window area of the foil security element is in register with the stated feature of the data carrier, so that said feature is recognizable to the viewer or a reading device through the break-through or window area.

The embedded or applied feature of the data carrier can involve for example printed patterns, characters or codings, a paper feature, a watermark or another information-containing security feature of the data carrier.

Obviously, a flat data carrier can be provided with a foil security element of the described type not only on one side but also on both sides. For example, a transparent or translucent area of the data carrier can be embedded between two foil security elements with accordingly disposed break-through areas or window areas to create a through-going translucent area of the data carrier.

The invention also comprises methods for producing the described data carriers. To produce a data carrier having a foil security element according to the first aspect of the invention,

a foil security element is supplied which comprises a foil substrate with a security feature,

a data carrier blank is supplied,

a break-through area is formed in the foil security element, said area comprising at least one gap breaking through the element, and

the broken-through foil security element is applied to the data carrier blank, which optionally has a break-through area.

The term “data carrier blank” designates the data carrier without the foil security element, that is, e.g. a printed bank note or a security paper that is to be provided with the foil security element.

The break-through area is advantageously produced in the foil security element or data carrier by perforation and/or punching.

For producing a data carrier having a foil security element according to the second aspect of the invention,

a foil security element is supplied, which comprises a foil substrate with a security feature,

a data carrier blank provided with a security feature is supplied,

a window area is formed in the foil security element, and

the foil security element is applied to the data carrier blank in such a way that the security feature of the data carrier is recognizable through the window area.

It is not required that the security feature is recognizable through the window area completely, although this may be advantageous in some cases, e.g. with an embedded watermark. In other cases, e.g. when the security feature is formed by an ink layer, a luminescent layer or a layer with optically variable effects, it is preferable to partly cover the security feature if only for the sake of simple production. Also, a protruding area of the security feature can serve as an orientation feature during a machine check of the data carrier, as described in detail below.

The window area is preferably produced by partly removing an opaque cover layer, in particular by demetallizing a metal layer of the foil security element.

In both method variants, the data carrier can be provided in a partial area with a security layer which contains a security feature. The security layer is advantageously printed, sprayed or doctored on, in particular applied by screen printing, flexographic printing or gravure printing. Application of the foil security element to the data carrier blank is preferably done by the transfer method.

The foil security element is always applied to the data carrier in the above embodiments. However, it is obvious to the expert that the foil security element can also be completely or partly embedded in a data carrier, in particular in a value document, in the manner of a security thread or a windowed security thread.

Further embodiments as well as advantages of the invention will be explained hereinafter with reference to the figures. For more clarity, the figures do without a representation that is true to scale and to proportion.

The drawings are described as follows:

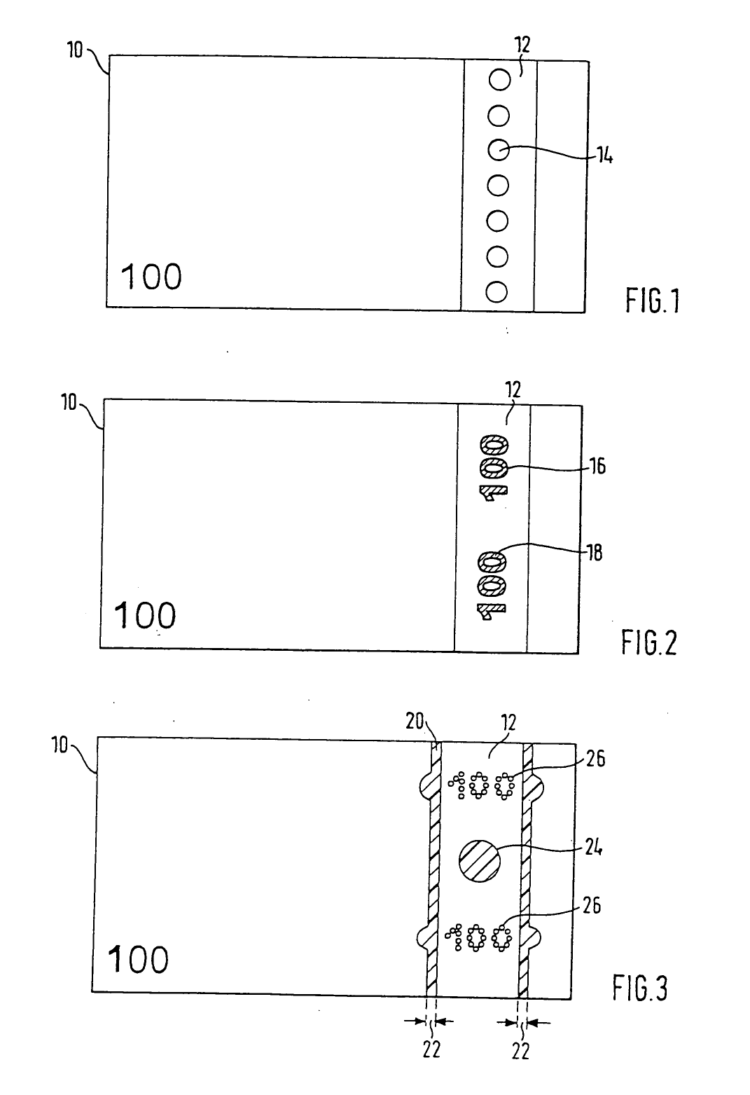

FIG. 1 shows a schematic representation of a bank note with an applied foil application strip according to one embodiment of the invention,

FIGS. 2 to 4 show further inventive embodiments for bank notes with applied foil application strips,

FIG. 5 shows a bank note with two different foil application elements in patch form, each according to a further embodiment of the invention, and

FIG. 6 shows a section through one of the foil application elements of FIG. 5 along the line VI-VI.

The invention will now be illustrated by the example of a bank note. FIG. 1 elucidates the basic principle by a schematic representation of a bank note 10 which is provided with a hologram foil application strip 12 applied by means of hot-melt adhesive. The foil application strip 12 has a plastic layer or lacquer layer as a carrier foil, which is provided with diffraction structures in the form of a relief structure. The plastic layer has applied thereto a metallic reflecting layer, typically made of aluminum. Such foil application strips are per se known to the expert, so that a more detailed description is unnecessary.

The foil application strip 12 has a punched-out row of openings 14 which extend through the total thickness of the strip 12. At the places of the foil application strip 12 that are provided with the openings 14 the surface of the bank note is then visible to the viewer. The foil application strip 12 is supplemented by a haptic authenticity mark through the openings 14. Additionally, the exposed surface areas in the openings 14 can be equipped with further security features, as to be described more exactly hereinafter.

In the embodiment of FIG. 2, the openings 16 are designed in the hologram foil application strip 12 in the form of the number “100” stating the denomination of the bank note 10. In this embodiment the foil application strip 12 is glued to a surface area of the bank note 10 where a security layer 18 was previously printed. In the embodiment the security layer 18 is formed by a printed layer containing fluorescent particles whose emission wavelength is selected in the visible spectral range for the sake of simple detectability.

The fluorescent particles of the printed layer are recognizable in the area of the openings 16 and can be caused to glow for example by a suitable excitation source, such as a UV lamp, during the check of authenticity of the bank note 10. The lack of this luminescence feature can be easily recognized by a viewer or an automatic reading device, thereby indicating tampering or copying of the bank note 10. At the same time, the openings 16 constitute due to their form a characteristic haptic recognition feature which can be used for authenticity checking without a check of luminescence.

A further embodiment of the invention is shown in FIG. 3. Here, the surface area of the bank note 10 printed by a luminescent security layer 20 is formed somewhat larger than the foil application strip 12 itself, resulting in a luminescent area 22 located outside the strip 12. This permits a simple authenticity check by machine, since the luminescent signal of the areas 22 indicates to a reading device where the openings 24, 26 of the foil application strip 12 are to be found.

The foil application strip 12 contains besides a large-area opening 24 also a number of microopenings 26 which are so disposed as to represent the denomination of the bank note 10. FIG. 3 exaggerates the size of the microopenings 26 for clarity's sake. In reality, the microopenings can have a diameter of 100 μm or less, or even of 50 μm or less.

If the emission wavelength of the luminescent particles is in the visible spectral range, as in the case of the embodiment of FIG. 2, the large-area opening 24 can serve as an easily recognizable visual authenticity mark for a viewer. The luminescent signal of the microopenings 26, in contrast, is weak due to the small diameter of the openings 26 and can only be detected with suitable detectors in a reading device. The luminescence radiation of the large-area opening 24 can serve during the authenticity check as a reference signal to which the expected weak signal of the microopenings is calibrated. The luminescence of the microopenings 26 is hard to reproduce for third parties and thus contributes to high falsification security of the bank note 10.

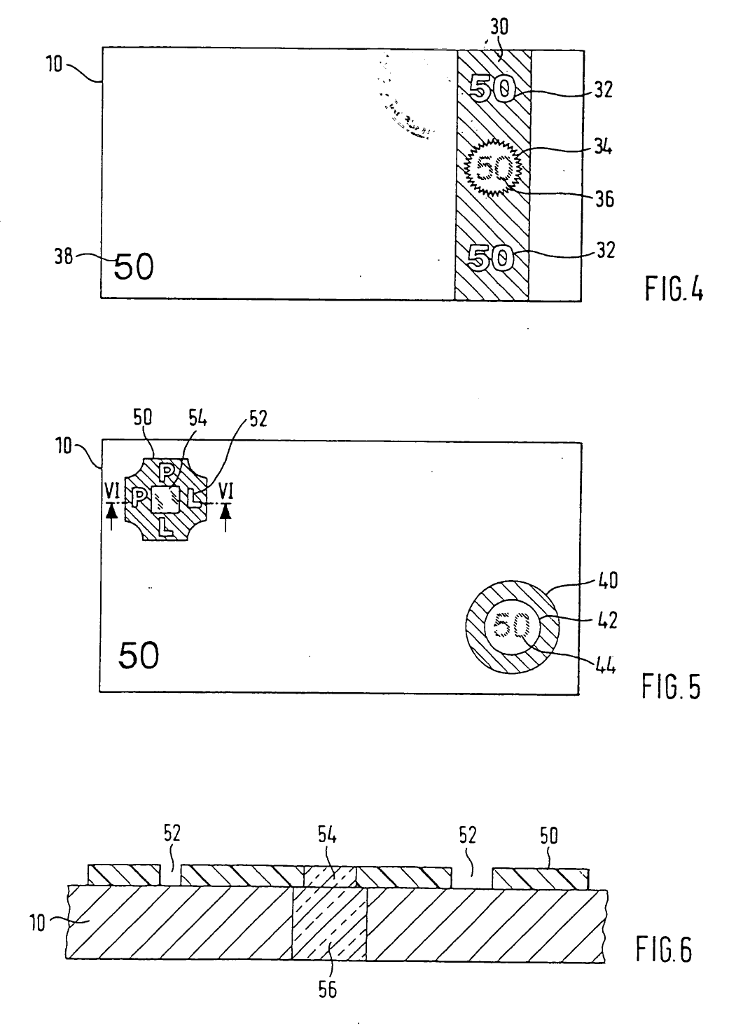

FIG. 4 shows a further embodiment of the invention in which a hologram foil application strip 30 with window areas 32, 34 is applied to the bank note 10. Departing from the above-described embodiments, the window areas 32, 34 do not constitute recesses in the foil material but are formed by demetallized and thus transparent areas in the otherwise opaque metal layer of the foil strip 30.

The two window areas 32 are designed in the form of the numerical value of the bank note denomination, in the embodiment in the form of the number “50”, and permit an unobstructed view of the surface of the bank note 10. The window areas 32 thus form striking negative information in the hologram strip 30 otherwise appearing with an optically variable effect. The bank note surface below the window areas 32 can be untreated, or be provided with an ink layer or an effect layer, such as a layer containing luminescent or optically variable particles.

The hologram strip 30 further contains a large-area window area 34 which is disposed in register with a watermark 36 embedded in the bank note paper. In this embodiment, the watermark 36 likewise represents the numerical value of the currency denomination, so that a comparison of the watermark 36, the window areas 32 and the printed denomination 38 permits a check of authenticity of the bank note. The edge of the large-area window area 34 is provided with a fine-scale structure to further impede the imitation and reproduction of the hologram strip 30.

FIG. 5 shows a bank note 10 with two different foil application elements 40, 50 in patch form according to further embodiments of the invention. The patch element 40 corresponds in its structure largely to the above-described hologram strip 30. A central window area 42 of the hologram patch 40 permits an unobstructed view of a watermark 44 relative to which the hologram patch 40 is disposed in register on the bank note. In the embodiment, the window area 42 is formed by a demetallized area of the hologram patch 40. However, it is likewise possible to provide the hologram patch 40 with an equally-sized punching which exposes the watermark 44.

The patch element 50 has a transparent central window area 54 besides through openings 52 in letter form. As can be seen best in joint viewing with FIG. 6, which shows a cross section of the bank note in the area of the patch element 50, the bank note has a translucent area 56 below the window area 54.

The translucent area 56 can be produced e.g. by the action of a suitable substance on the bank note paper. In this embodiment, concentrated sulfuric acid was used for this purpose. The combination of the window area 54 of the patch element with the translucent area 56 of the bank note results in a characteristic area inside the patch element 50 that appears light in transmission.

1. A foil security element for application to a data carrier, such as a bank note, paper of value, or identity card, said element comprising a foil substrate provided with a security feature, and a breakthrough area with at least one gap breaking through the element.

2. The foil security element according to claim 1, wherein the break-through area has a plurality of gaps breaking through the element in the form of patterns, characters or codings.

3. The foil security element according to claim 1, wherein the break-through area has an extensive gap through which a subjacent security feature of the data carrier is recognizable by at least one of visually and by machine.

4. A foil security element for application to a data carrier, such as a bank note, paper of value, or identity card, said element comprising a foil substrate provided with a security feature, wherein the foil security element has a window area through which a subjacent security feature of the data carrier is recognizable.

5. The foil security element according to claim 4, wherein the window area is configured in the form of a pattern, character or coding.

6. The foil security element according to claim 1, wherein the foil security element forms a security strip, a security thread or a flat transfer element for application to a data carrier.

7. A data carrier, such as a bank note, paper of value, or identity card, comprising a foil security element according to claim 1 disposed on the surface thereof.

8. The data carrier according to claim 7, wherein the data carrier has a security feature at least partly covered by the foil security element and recognizable by at least one of visually and by machine through the break-through area or the window area.

9. The data carrier according to claim 8, wherein the security feature is embedded inside the data carrier.

10. The data carrier according to claim 8, wherein the data carrier is provided in a partial area with a security layer containing the security feature.

11. The data carrier according to claim 10, wherein the security layer contains at least one security feature selected from the group consisting of luminescent, metallic, magnetic or electroconductive substances and optically variable pigments.

12. The data carrier according to claim 7, wherein the data carrier contains a transparent or translucent area which is recognizable through the break-through area or the window area.

13. The data carrier according to claim 7, wherein the data carrier contains at least two security features with different physical properties which are recognizable by at least one of visually and by machine through the break-through area or the window area.

14. The data carrier according to claim 13, wherein the security features are disposed side by side, one above the other, or partly overlapping each other.

15. The data carrier according to claim 7, wherein the break-through area or window area of the foil security element forms at least one of visually and machine detectable information which is identical in content to, or supplements, other information on the data carrier or the foil security element.

16. The data carrier according to claim 15, wherein at least part of the information on the data carrier is detectable by at least one of visually and by machine through the break-through area or the window area.

17. The data carrier according to claim 7, wherein the foil security element is applied to the data carrier in register with the total geometry of the data carrier or with an embedded or applied feature of the data carrier.

18. The data carrier according to claim 17, wherein the embedded or applied feature of the data carrier is formed by printed patterns, characters or codings, by a paper feature, a watermark or another information-containing security feature of the data carrier.

19. The data carrier according to claim 7, wherein the data carrier has a break-through or window area which preferably at least partly overlaps the break-through or window area of the foil security element.

20. A method for producing a data carrier comprising the steps of
supplying a foil security element comprising a foil substrate with a security feature,
supplying a data carrier blank,
forming in the foil security element a break-through area with at least one gap breaking through the element, and
applying the broken-through foil security element to the data carrier blank.

21. The method according to claim 20, wherein the break-through area is perforated or stamped into the foil security element.

22. A method for producing a data carrier comprising the steps of
supplying a foil security element comprising a foil substrate with a security feature,
supplying a data carrier blank with a security feature,
forming a window area in the foil security element, and
applying the foil security element to the data carrier blank, so that the security feature of the data carrier is recognizable through the window area.

23. The method according to claim 22, wherein the window area is produced by partly removing an opaque cover layer.

24. The method according to claim 20, wherein the data carrier is provided in a partial area with a security layer containing a security feature.

25. The method according to claim 24, wherein the security layer is printed, sprayed or doctored on as by screen printing, flexographic printing or gravure printing.

26. The method according to claim 20, wherein the foil security element is applied to the data carrier blank by the transfer method.

27. A data carrier, such as a bank note, paper of value, or identity card comprising a foil security element according to claim 4 disposed on the surface thereof.

28. The method according to claim 22, wherein the data carrier is provided in a partial area with a security layer containing a security feature.

29. The method according to claim 22, wherein the foil security element is applied to the data carrier blank by the transfer method.
